(19) United States
(12) Patent Application Publication
(10) Pub. No.: US 2019/0214180 A1
(43) Pub. Date: Jul. 11, 2019

(54) MAGNETIC SHEET AND WIRELESS POWER RECEIVING DEVICE COMPRISING SAME

(71) Applicant: LG INNOTEK CO., LTD., Seoul (KR)

(72) Inventors: JONG HEUM YOON, Seoul (KR); SANG WON LEE, Seoul (KR); SEOK BAE, Seoul (KR); SUN YOUNG YU, Seoul (KR)

(21) Appl. No.: 16/331,042

(22) PCT Filed: Sep. 12, 2017
(86) PCT No.: PCT/KR2017/009967

§ 371 Date: Mar. 7, 2019

(30) Foreign Application Priority Data
Sep. 12, 2016 (KR) 10-2016-0117619

(51) Int. Cl. H01F 27/245; H02J 50/10; H01F 38/14; H01F 27/28

(52) U.S. Cl. CPC H01F 27/245; H02J 50/10; H02J 7/025; H01F 27/28; H01F 38/14

(57) ABSTRACT

A magnetic sheet according to an embodiment comprises: a first magnetic sheet portion comprising a first surface; a second magnetic sheet portion comprising a second surface that faces the first surface; and an attachment portion arranged between the first surface and the second surface, wherein the attachment portion may comprise a plurality of magnetic particles and a coating layer that is coated with the plurality of magnetic particles and comprises an organic material.

### TECHNICAL FIELD

Embodiments relate to a magnetic sheet and a wireless power reception device including the same.

### BACKGROUND ART

As a near field communication (NFC) function is employed in mobile phones such as smartphones, the NFC function has been widely used in a payment means, a transportation card, an access card or point-to-point (P2P) information exchange between mobile phones. Since NFC uses 13.56 MHz and uses a very short range communication method operating only within a distance of up to 20 cm, NFC is safe against hacking and is suitable as a payment means.

An NFC antenna (not shown) for implementing such an NFC function is disposed on the back surface of a battery included in a smartphone (not shown), is installed on a back surface of a smartphone case or is subjected to in-molding in consideration of a size thereof. In particular, the case of the smartphone battery is made of metal and thus electromagnetic energy generated in the NFC antenna is absorbed by the battery case functioning as a parasitic coupler. Accordingly, the communication sensitivity of the NFC antenna is lowered and, as a result, a communication distance becomes very short. Therefore, electromagnetic isolation between the metal battery case and the NFC antenna is required. As an isolation means, a magnetic sheet having a thickness of 1 mm or less and permeability is mainly used.

Meanwhile, recently, wireless charging (that is, wireless power transmission and reception) technology has attracted considerable attention. Representative examples of a wireless power transmission standard may include Wireless Power Consortium (WPC), Alliance for Wireless Power (A4WP) and Power Matters Alliance (PMA). The wireless power transmission method is technically classified into a magnetic induction method and a magnetic resonance method. As a result, a magnetic material for magnetic induction or magnetic resonance is used in a transmission and reception module of a wireless charging system. Attempts to minimize electromagnetic energy loss by introducing a magnetic sheet as an electromagnetic shielding material have been conducted. Efforts have been continuously made to improve transmission efficiency (wireless power transmission) function and performance which have depended on coil design.

Typical magnetic sheet materials include a sheet including a ferrite material, a composite sheet including metal powder and polymer resin and a metallic-alloy based magnetic ribbon sheet or a metallic ribbon sheet including only a metallic ribbon. The sheet including the ferrite material has good permeability but has a restricted thickness due to limitation of high-temperature firing and magnetic flux density and the composite sheet has low permeability. In contrast, the metallic ribbon sheet may obtain high permeability and magnetic flux density with a small thickness.

The metallic ribbon is an amorphous or nanocrystalline metal or alloy, which is manufactured in the form of a very thin foil through an atomizer. Such a metallic ribbon is generally used in a stacked structure having a plurality of layers in order to obtain desired shielding properties. Since energy transmitted in near field communication or wireless charging is a magnetic field with a frequency, if a magnetic sheet is configured in the form of a lump instead of the stacked structure, conductivity increases and thus eddy current loss exponentially increases.

In order to stack layers, a ribbon and an adhesive file having an insulating function are alternately disposed. However, if the adhesive film is disposed between ribbons, effective permeability decreases due to magnetic flux loss occurring in the adhesive film, thereby lowering transmission efficiency. In addition, if the number of stacked layers is increased in order to compensate for the effective permeability, the thickness of the magnetic sheet may increase.

### DISCLOSURE

### Technical Problem

Embodiments provide a magnetic sheet capable of providing high transmission efficiency while decreasing thickness, and a wireless power reception device including the same.

### Technical Solution

Embodiments provide a magnetic sheet including a first magnetic sheet portion including a first surface, a second magnetic sheet portion including a second surface facing the first surface, and an adhesive portion disposed between the first surface and the second surface, wherein the adhesive portion includes a plurality of magnetic particles; and a coating layer applied to the plurality of magnetic particles and including an organic material.

For example, the thickness of the coating layer may be 10 nm to 100 nm.

For example, the weight ratio of the magnetic particles may be 50% or less that of the adhesive portion.

For example, the adhesive portion may further include an adhesive, and at least some of the plurality of magnetic particles may be dispersed in the adhesive.

For example, the adhesive may include at least one of acrylic resin, urethane resin, epoxy resin, silicon resin, phenol resin, amino resin, unsaturated polyester resin, polyurethane resin, urea resin, melamine resin, polyimide resin, diallyl phthalate resin or modified resin thereof.

For example, the coating layer may include at least one of aminosilane, vinylsilane, epoxysilane, methacrylsilane, alkylsilane, phenylsilane or chlorosilane as the organic material.

For example, the adhesive and the organic material may be composed of the same material.

For example, the adhesive and the organic material may be composed of different materials.

For example, the thickness of the adhesive portion in a direction from the first surface to the second surface may be 0.1 μm to 10 μm.

For example, the thickness of the adhesive portion in the direction from the first surface to the second surface may be uniform.

For example, the thickness of the adhesive portion in the direction from the first surface to the second surface may not be uniform.

For example, the thickness of each of the first and second magnetic sheet portions may be 10 μm to 200 μm.

For example, at least one of the first or second surface may include a recess, and the recess may receive at least one of the magnetic particles, the coating layer or the adhesive.

For example, in at least one of the first or second magnetic sheet portions, a plurality of patterns including three or more lines radiated from a predetermined point may be formed.

For example, the pattern may be formed as cracks.

For example, the pattern may further include a frame surrounding two or more of three or more lines radiated from the predetermined point.

For example, the pattern may include a random shape.

For example, at least one of the first or second magnetic sheet portion may include a metallic ribbon.

For example, the magnetic particles may include a ferrite component.

Embodiments provide a magnetic sheet including at least three stacked magnetic sheet portions, and an adhesive portion disposed between two facing surfaces of adjacent magnetic sheet portions of the stacked magnetic sheet portions, wherein the adhesive portion includes a plurality of magnetic particles and a coating layer applied to the plurality of magnetic particles and including an organic material.

Embodiments provide wireless power reception device for receiving power from a wireless power transmission device including a substrate, a magnetic sheet disposed on the substrate, and a coil disposed on the magnetic sheet to receive electromagnetic energy radiated from the wireless power transmission device, wherein the magnetic sheet includes a first magnetic sheet portion including a first surface, a second magnetic sheet portion including a second surface facing the first surface, and an adhesive portion disposed between the first surface and the second surface, and wherein the adhesive portion includes a plurality of magnetic particles and a coating layer applied to the plurality of magnetic particles and including an organic material.

For example, the wireless power reception device may be included in a mobile terminal.

### Advantageous Effects

In a magnetic sheet and a wireless power reception device including the same according to an embodiment, an adhesive portion including a plurality of magnetic particles coated with an organic coating layer is disposed among a plurality of magnetic sheet portions, thereby obtaining stable adhesion among the plurality of magnetic sheet portions, high effective permeability and high transmission efficiency while decreasing thickness.

### DESCRIPTION OF DRAWINGS

FIG. 1 is a diagram showing an existing magnetic induction type equivalent circuit.

FIG. 2 is a block diagram showing a wireless power reception device as one of subsystems configuring a wireless charging system.

FIG. 3 is a plan view showing a portion of a wireless power reception device according to an embodiment.

FIGS. 4a and 4b are cross-sectional views of a magnetic sheet according to an embodiment.

FIGS. 5a and 5b are cross-sectional views of a magnetic particle according to an embodiment.

FIGS. 6a to 6c are cross-sectional views showing a method of manufacturing the magnetic sheet 210A shown in FIG. 4a.

FIG. 7a is a cross-sectional view showing the effect of the magnetic particles P coated with a coating layer 520 according to an embodiment along with a comparison example, and FIG. 7b is an enlarged cross-sectional view of a portion “E3”.

FIG. 8 is a cross-sectional view illustrating recesses 810 to 840 disposed in magnetic sheet portions R1 and R2 adjacent to an adhesive portion A1 according to an embodiment.

FIG. 9a is a cross-sectional view illustrating the magnetic properties of a magnetic sheet according to an embodiment, and FIG. 9b is a cross-sectional view illustrating the magnetic properties of a magnetic sheet according to a comparison example.

FIG. 10 is a graph showing comparison between actual permeabilities according to each frequency before and after a crack is formed in a metallic ribbon.

FIGS. 11 to 13 are top views of a magnetic sheet portion according to an embodiment.

FIGS. 14 to 15 are top views of a magnetic sheet portion according to another embodiment.

FIG. 16 is a top view of a magnetic sheet portion according to another embodiment.

### MODE FOR INVENTION

Hereinafter, exemplary embodiments will be described in detail with reference to the accompanying drawings. The embodiments may be modified in various ways. However, this is not intended to limit the embodiments to the specific embodiments. Embodiments are provided for full understanding of the disclosure.

In the following description of the embodiments, it will be understood that, when each element is referred to as being formed “on” or “under” the other element, it can be directly “on” or “under” the other element or be indirectly formed with one or more intervening elements therebetween.

In addition, it will also be understood that “on” or “under” the element may mean an upward direction and a downward direction of the element.

In addition, the relative terms “first” and “second”, “top/upper/above”, “bottom/lower/under” and the like in the description and in the claims may be used to distinguish between any one substance or element and other substances or elements and not necessarily for describing any physical or logical relationship between the substances or elements or a particular order.

Hereinafter, a magnetic sheet 210 and a wireless power reception device 200 including the same according to an embodiment will be described with reference to the accompanying drawings. For convenience, although the magnetic sheet 210 and the wireless power reception device 200 including the same are described using a Cartesian coordinates system (x-axis, y-axis and z-axis), the magnetic sheet 210 and the wireless power reception device 200 including the same may be described using other coordinate systems. In the Cartesian coordinates system, the x-axis, the y-axis and the z-axis are orthogonal to each other but the embodiment is not limited thereto. That is, the x-axis, the y-axis and the z-axis may intersect without being orthogonal to each other.

The terms and abbreviations used in the embodiments will now be described.
Wireless charging system (wireless power transfer system): This includes a wireless power transmission device and a wireless power reception device.
Wireless power transmission device (wireless power transfer system-charger) or transmission unit: This is a device for providing wireless power transmission to power receivers of a plurality of apparatuses within a magnetic field and managing the wireless charging system.
Wireless power reception device (Wireless power transfer device) or reception unit: This is a device for receiving wireless power from the wireless power transmission device within a magnetic field.
Charging Area: This is an area in which wireless power transmission is performed within a magnetic field. The range of the area may be changed according to the size, required power or operating frequency of an application product.

S parameter (Scattering parameter): This is a ratio of an input voltage to an output voltage in a frequency distribution and is a ratio of an input port to an output port or a reflection value of an input/output port, that is, an output value returned by reflection of an input value.

Q (Quality factor): In resonance, a value Q means frequency selection quality. As the Q value increases, a resonance property becomes better, and the Q value is represented by a ratio of energy stored in a resonator to lost energy.

The wireless power transmission device for transmitting power to be received by the wireless power reception device may selectively use various frequency bands from a low frequency (50 kHz) to a high frequency (15 MHz). In addition, the wireless power transmission device requires support of a communication system capable of exchanging data and control signals in order to control the wireless charging system.

The wireless power reception device of the embodiments is applicable to the mobile terminal industry, the smart watch industry, the computer and laptop industries, the home appliance industry, the electric vehicle industry, the medical device industry, robotics, etc. using electronic devices which use or require respective batteries.

In embodiments, a wireless charging system capable of transmitting power to one or more apparatuses using one or a plurality of transmission coils may be considered.

According to embodiments, a battery shortage problem of a mobile device such as a smartphone or a laptop may be solved. For example, when a smartphone or a laptop is used in a state of being placed on a wireless charging pad located on a table, the battery may be automatically charged and thus the smartphone or the laptop can be used for a long time. In addition, when wireless charging pads are installed in public places such as cafés, airports, taxis, offices and restaurants, various mobile apparatuses may be charged regardless of the type of the charging terminal differing according to mobile apparatus manufacturer. In addition, when wireless power transmission technology is applied to household appliances such as cleaners, electric fans, etc., effort to find a power cable is not necessary and complicated wires are not required in the home, thereby reducing the number of wires in a building and making better use of space. In addition, charging an electric vehicle using a household power supply takes considerable time. In contrast, when high power is transferred through wireless power transmission technology, charging time can be reduced. In addition, when wireless charging equipment is mounted in a parking area, a power cable does not need to be provided near the electric vehicle.

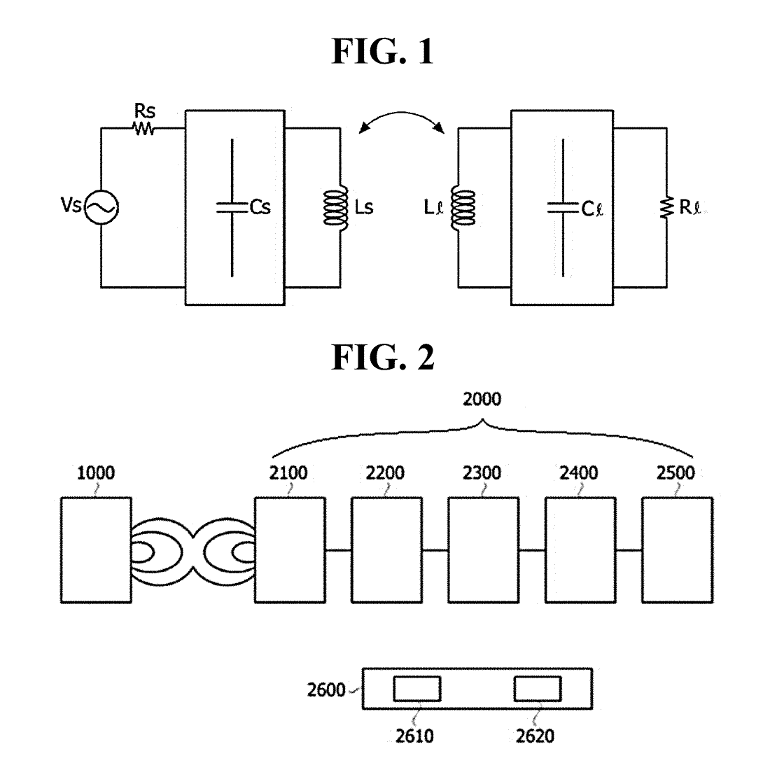

The magnetic sheet according to the embodiment is applicable to various fields as described above. Hereinafter, to facilitate understanding of the magnetic sheet according to the embodiment, a wireless power reception device according to an embodiment, which includes the magnetic sheet, will be described first with reference to FIGS. 1 to 3.

FIG. 1 is a diagram showing an existing magnetic induction type equivalent circuit.

As the wireless power transmission principle, there is a magnetic induction method. The magnetic induction method uses non-contact energy transmission technology for disposing a source inductor Ls and a load inductor Ll close to each other and generating electromotive force in the load inductor Ll by magnetic flux generated when current flows in the source inductor Ls.

In the magnetic induction type equivalent circuit shown in FIG. 1, a transmission unit may be implemented by a source voltage Vs, a source resistor Rs, and a source capacitor Cs for impedance matching, and a source coil Ls for magnetic coupling with a reception unit according to a device for supplying power and a reception unit may be implemented by a load resistor Rl which is an equivalent resistor of the reception unit, a load capacitor Cl for impedance matching and a load coil Ll for magnetic coupling with the transmission unit. Magnetic coupling between the source coil Ls and the load coil Ll may be represented by mutual inductance Msl.

In FIG. 1, when a ratio of an input voltage to an output voltage is obtained from a magnetic induction equivalent circuit including only coils without the source capacitor Cs and the load capacitor Cl for impedance matching, a maximum power transmission condition satisfies Equation 1 below.

Ls/Rs=Ll/Rl Equation 1

According to Equation 1 above, when a ratio of inductance of the transmission coil Ls to the source resistor Rs is equal to a ratio of the inductance of the load coil Ll to the load resistor Rl, maximum power transmission is possible. In a wireless charging system including only inductance, since a capacitor capable of compensating for reactance is not present, the reflection value of the input/output port cannot become 0 at a maximum power transfer point and power transfer efficiency can be significantly changed according to mutual inductance Msl. Therefore, as a compensation capacitor for impedance matching, the source capacitor Cs may be added to the transmission unit and the load capacitor Cl may be added to the reception unit. The compensation capacitors Cs and Cl may be connected to the reception coil Ls and the load coil Ll in series or in parallel, respectively. In addition, for impedance matching, passive elements such as additional capacitors and inductors may be further included in the transmission unit and the reception unit, in addition to the compensation capacitors.

The wireless charging system for transferring power using the magnetic induction method or the magnetic resonance method based on the above-described wireless power transmission principle will be described.

FIG. 2 is a block diagram of a general wireless charging system.

Referring to FIG. 2, the wireless charging system may include a transmission unit 1000 and a reception unit 2000 for wirelessly receiving power from the transmission unit 1000. The reception unit 2000 as one of the subsystems configuring the wireless charging system may include a reception side coil unit 2100, a reception side matching unit 2200, a reception side AC/DC converter 2300, a reception side DC/DC converter 2400, a load 2500 and a reception side communication and control unit 2600. In this specification, the reception unit 2000 is used interchangeably with the wireless power reception device.

The reception side coil unit 2100 may receive power through the magnetic induction method and may include one or a plurality of induction coils. In addition, the reception side coil unit 2100 may further include a near field communication (NFC) antenna. In addition, the reception side coil unit 2100 may be equal to a transmission side coil unit (not shown) and the dimensions of the reception antenna may be changed according to the electrical characteristics of the reception unit 2000.

The reception side matching unit 2200 may perform impedance matching between the reception unit 1000 and the reception unit 2000.

The reception side AC/DC converter 2300 may rectify an AC signal output from the reception side coil unit 2100 and generates a DC signal.

The reception side DC/DC converter 2400 may adjust the level of the DC signal output from the reception side AC/DC converter 2300 according to capacity of the load 2500.

The load 2500 may include a battery, a display, a sound output circuit, a main processor and various sensors.

The reception side communication and control unit 2600 may wake up by wakeup power from a transmission side communication and control unit (not shown), perform communication with the transmission side communication and control unit, and control operation of the subsystems of the reception unit 2000.

One or a plurality of reception units 2000 may be configured to wirelessly receive energy from the transmission unit 1000. That is, in the magnetic induction method, a plurality of independent reception side coil units 2100 may be provided such that one transmission unit 1000 supplies power to the plurality of target reception units 2000. At this time, a transmission side matching unit (not shown) of the transmission unit 1000 may adaptively perform impedance matching among the plurality of reception units 2000.

In addition, if the plurality of reception units 2000 is configured, the same type of system or different types of systems may be configured.

Meanwhile, in a relationship between the signal level and the frequency of the wireless charging system, in the case of magnetic induction type wireless power transmission, in the transmission unit 1000, a transmission side AC/DC converter (not shown) may receive and convert a 60-Hz AC signal of 110 V to 220 V into a DC signal of 10 V to 20 V and output the DC signal and a transmission side DC/AC converter may receive the DC signal and output an AC signal of 125 kHz. The reception side AC/DC converter 2300 of the reception unit 2000 may receive and convert the AC signal of 125 kHz into a DC signal of 10 V to 20 V and output the DC signal and the reception side DC/DC converter 2400 may output a DC signal suitable for the load 2500, for example, a DC signal of 5V, and transfer the DC signal to the load 2500.

Hereinafter, the wireless power reception device 200 according to the embodiment for performing at least some functions of the wireless power reception device 2000 shown in FIG. 2 will be described.

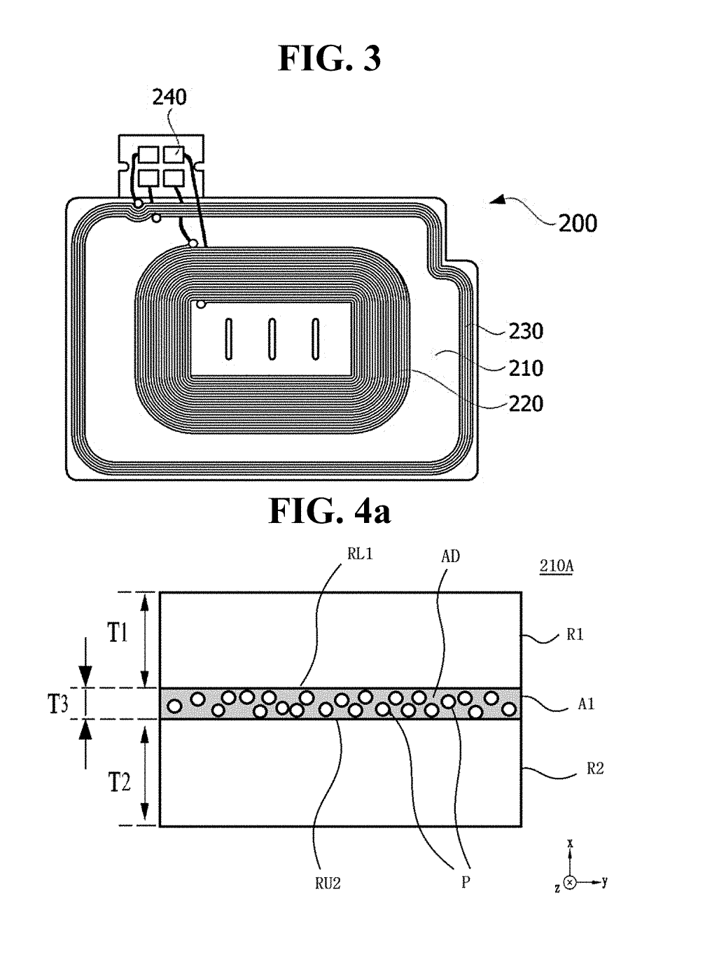

FIG. 3 is a plan view showing a portion of a wireless power reception device 200 according to an embodiment.

The wireless power reception device 200 includes a reception circuit (not shown), a magnetic sheet 210, and a reception coil 220. One or a plurality of magnetic sheets 210 may be disposed or stacked on a substrate (not shown). The substrate may be made of a plurality of fixed sheets and may fix the magnetic sheet 210 by bonding the magnetic sheet 210 thereto.

The magnetic sheet 210 collects electromagnetic energy radiated from the transmission coil (not shown) of the wireless power transmission device 1000.

The reception coil 220 is stacked on the magnetic sheet 210. The reception coil 220 is wound on the magnetic sheet 210 in a direction parallel to the magnetic sheet 210. For example, in a reception antenna applied to a mobile terminal such as a smartphone, a spiral coil having an outer diameter of 50 mm or less and an inner diameter of 20 mm or more may be used. The reception circuit converts electromagnetic energy received through the reception coil 220 into electric energy and charges a battery (not shown) with the converted electric energy.

Although not shown, a heat radiation layer may be further included between the magnetic sheet 210 and the reception coil 220.

Meanwhile, if the wireless power reception device 200 has a WPC function, a near field communication (NFC) function and a mobile payment function, an NFC coil 230 and a mobile payment coil (not shown) may be further stacked on the magnetic sheet 210. The NFC coil 230 and the mobile payment coil may have a planar shape surrounding the reception coil 220.

Each of the reception coil 220 and the NFC coil 230 may be electrically connected to an external circuit (e.g., an integrated circuit) (not shown) through a terminal 240.

Although both the reception coil 220 and the NFC coil 230 are disposed on one magnetic sheet 210 in FIG. 3, this is merely an example. In another embodiment, separate magnetic sheets respectively corresponding to the coils 220 and 230 may be respectively disposed in the regions of the coils 220 and 230. In this case, the magnetic sheets respectively corresponding to the coils may be configured to have different shielding properties or the same shielding properties. In addition, although the NFC coil 230 is shown as surrounding the outside of the reception coil 220 in FIG. 3, this is merely an example and the coils may be formed to be spaced apart from each other, such that any one of the two coils 220 and 230 does not surround the other coil.

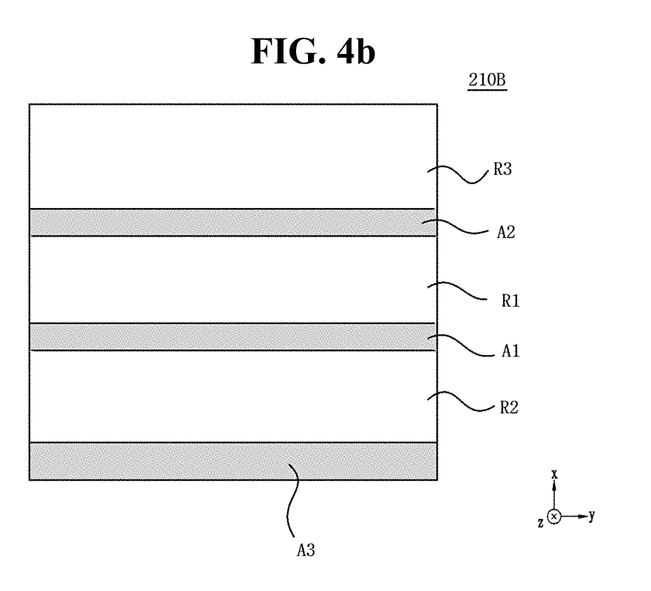

Hereinafter, the structure, process and magnetic properties of the magnetic sheet according to the present embodiment will be described with reference to FIGS. 4a to 9b.

FIGS. 4a and 4b are cross-sectional views of a magnetic sheet according to an embodiment.

Referring to FIG. 4a, the magnetic sheet 210A according to the embodiment may include a first magnetic sheet portion R1, a second magnetic sheet portion R2 and an adhesive portion A1. At least some of the first magnetic sheet portion R1, the second magnetic sheet portion R2 and the adhesive portion A1 may be stacked to overlap each other in an x-axis direction. More specifically, the adhesive portion A1 may be disposed between the lower surface RL1 of the first magnetic sheet portion R1 and the upper surface RU2 of the second magnetic sheet portion R2.

At least one of the first magnetic sheet portion R1 or the second magnetic sheet portion R2 may be composed of a metallic-alloy based magnetic ribbon. In this specification, a ribbon is defined as a crystalline or amorphous metallic alloy having a very thin band or string shape. In addition, the ribbon defined in this specification is a metallic alloy in principle, but the term ribbon is used due to the appearance thereof. The ribbon is mainly made of Fe—Si—B and may have various compositions by adding at least one additive such as at least one of Nb, Cu or Ni. Of course, the magnetic sheet portion composed of a ribbon is merely an example. In another embodiment, the magnetic sheet portion may be composed of a ribbon composed of a metal-based magnetic powder consisting of one or more elements selected from Fe, Ni, Co, Mo, Si, Al and B or a composite material of the ribbon and a polymer.

The thickness T1 of the first magnetic sheet portion R1 and the thickness T2 of the second magnetic sheet portion R2 in the x-axis direction may be the same or different. In addition, the thicknesses T1 and T2 of the magnetic sheet portions R1 and R2 in the x-axis direction may or may not be uniform in the y-axis and z-axis directions.

For example, the thicknesses T1 and T2 of the magnetic sheet portions R1 and R2 in the x-axis direction may be 10 μm to 200 μm.

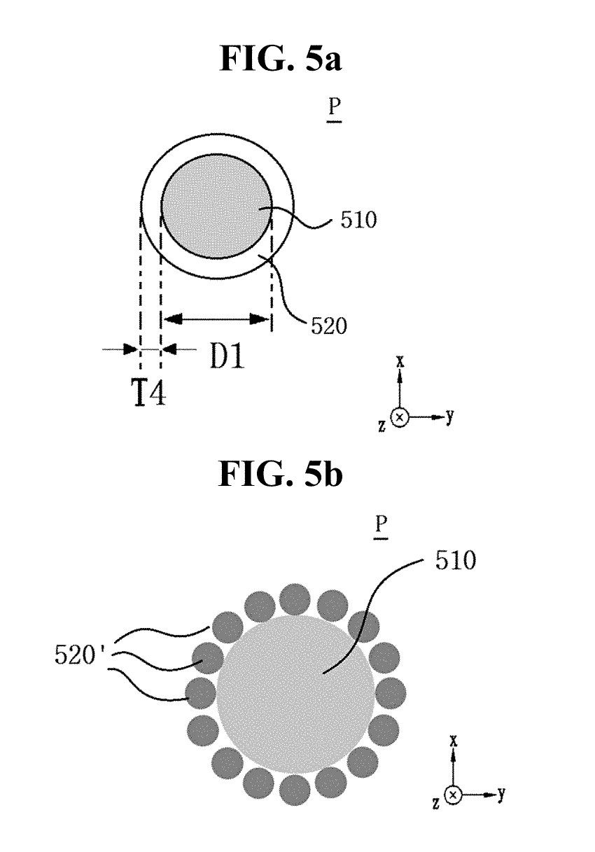

In addition, the adhesive portion A1 may include an adhesive AD and magnetic particles P dispersed in the adhesive AD. The magnetic particle P may be provided with a coating layer including an organic material. The coating layer and the magnetic particle will be described below in greater detail with reference to FIG. 5.

The thickness T3 of the adhesive portion A1 in a direction from the lower surface RL1 of the first magnetic sheet portion R1 to the upper surface RU2 of the second magnetic sheet portion R2 facing the same (that is, in the x-axis direction) may be 0.1 μm to 10 μm, without being limited thereto. In addition, the thickness T3 of the adhesive portion A1 may or may not be uniform in the y-axis and z-axis directions.

The adhesive AD includes an organic material. Examples of the organic material include acrylic resin, urethane resin, epoxy resin, silicon resin, phenol resin, amino resin, unsaturated polyester resin, polyurethane resin, urea resin, melamine resin, polyimide resin, diallyl phthalate resin and modified resin thereof.

If the weight ratio of the magnetic particles exceeds 50% of the total weight ratio (wt %) of the adhesive portion, adhesive force is significantly lowered. Therefore, the weight ratio of the magnetic particles is 50% or less.

The magnetic sheet 210A shown in FIG. 4a shows the minimum configuration unit according to the present embodiment. The magnetic sheet according to the embodiment may include more magnetic sheet portions and adhesive portions disposed between adjacent magnetic sheet portions. For example, as shown in FIG. 4b, in the magnetic sheet 210B, a third magnetic sheet portion R3 may be disposed on the first magnetic sheet portion R1, and an adhesive portion A2 may be disposed between the surfaces, which face each other, of the first magnetic sheet portion R1 and the third magnetic sheet portion R3. In addition, an adhesive portion A3 may be further provided below the second magnetic sheet portion R2. If the second magnetic sheet portion R2 is disposed on the lowermost end of the magnetic sheet portions included in the magnetic sheet 210B, the adhesive portion A3 disposed below the second magnetic sheet portion R2 may have a greater thickness than the other adhesive portions A1 and A2 in the x-axis direction, and the magnetic particles may not be included in the adhesive portion A3. A substrate (not shown) of the wireless power reception device may be disposed below the adhesive portion A3 disposed below the second magnetic sheet portion R2.

Next, the magnetic particle according to the embodiment will be described in greater detail with reference to FIGS. 5a and 5b.

FIGS. 5a and 5b are cross-sectional views of a magnetic particle according to an embodiment.

As described above, at least a portion of the magnetic particle 510 may be surrounded by a coating layer 520. The coating layer 520 may be in a state of being cured at the outer periphery of the magnetic particle 510.

The magnetic particle 510 may be composed of a material having nonconductivity or weak conductivity in order to reduce eddy current loss. For example, the magnetic particle 510 may be ferrite, without being limited thereto. In another embodiment, the magnetic particle 510 may be composed of magnetic stainless steel (Fe—Cr—Al—Si), sendust (Fe—Si—Al), fermalloy (Fe—Ni), Fe—Si alloy, silicon copper (Fe—Cu—Si), Fe-S?B(—Cu—Nb) alloy, Fe—Si—Cr—Ni alloy, Fe—Si—Cr alloy, Fe—Si—Al—Ni—Cr alloy, etc.

The size D1 of the magnetic particle 510 may be 5 μm or less. For example, considering a narrow distribution interval between particles for maintaining adhesive force, the size D1 of the magnetic particle 510 may be 1 μm or less.

The coating layer 520 may be formed of the same material as or a material different from the adhesive AD. The material configuring the coating layer 520 may be included in the form of silane which is a building block of a silicon chemical property. That is, the coating layer 520 includes an organic material. Examples of the organic material include aminosilane, vinylsilane, epoxysilane, methacrylsilane, alkylsilane, phenylsilane, chlorosilane or a combination of two or more thereof.

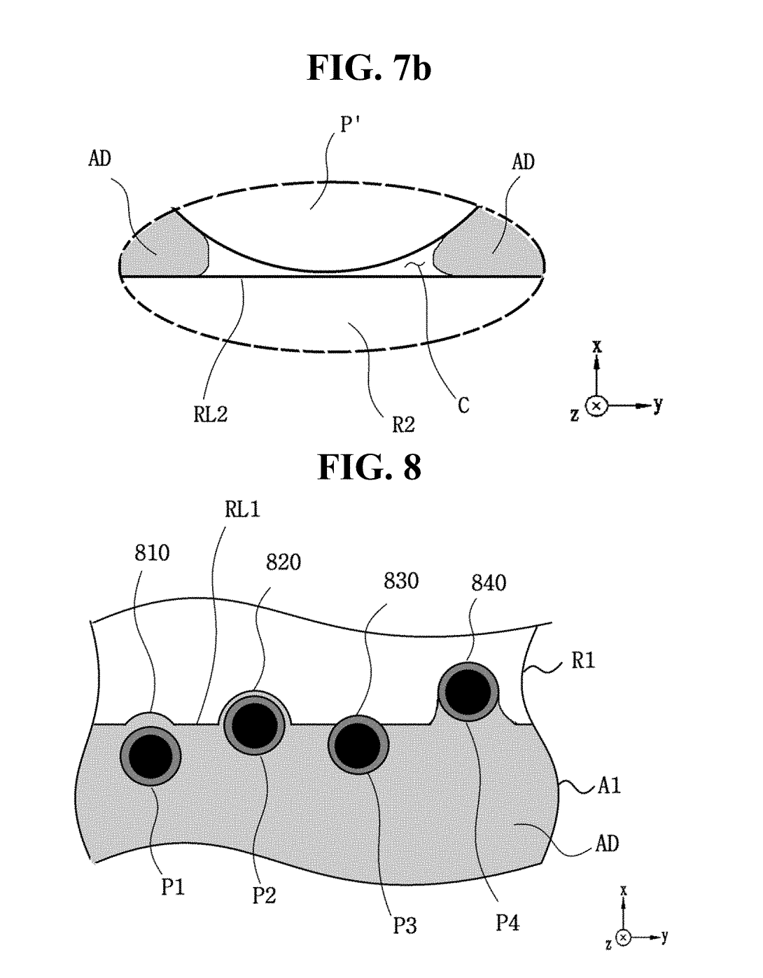

Since the coating layer 520 includes an organic material, the adhesive AD includes an organic material. Therefore, due to affinity between the organic materials of the coating layer 520 and the adhesive AD, properties that the adhesive AD is not separated from the outer surface of the coating layer 520 occur. This effect will be described in greater detail with reference to FIGS. 7a and 7b.

If the thickness T4 of the coating layer 520 exceeds 1 μm, the entire circumferences of the magnetic particles 510 and 520 increase and the thickness of the adhesive portion A1 increases, thereby bonding the magnetic particles P to each other. In addition, if the thickness T4 of the coating layer 520 is less than 10 μm, coupling (affinity between the organic materials) may be weak and thus the function of the coating layer 520 for bonding the magnetic particle 510 and the adhesive AD to each other may be weakened. Accordingly, the thickness T4 of the coating layer 520 may be 1 μm or less and, preferably in a range of 10 nm to 100 nm.

Of course, the thickness T4 of the coating layer 520 may or may not be uniform. For example, as shown in FIG. 5b, particles of the organic material may form the coating layer 520′ in a three-dimensional form.

If the thickness T4 of the coating layer 520 is not uniform, at least a portion of the outer surface of the magnetic particle 510 may not be coated with the coating layer 520 and may be exposed to the outside.

Although a circular cross-sectional shape is shown in FIGS. 5a and 5b on the assumption that the magnetic particle has a spherical shape, this is merely example and the magnetic particle may have an angular shape or a plate shape and thus the magnetic particle may have various cross-sectional shapes such as an ellipse, a polygon or a combination thereof.

Hereinafter, a method of manufacturing the magnetic sheet 210A shown in FIG. 4a will be described with reference to the drawings. In addition, the magnetic sheet 210B shown in FIG. 4b may be manufactured based on the below description.

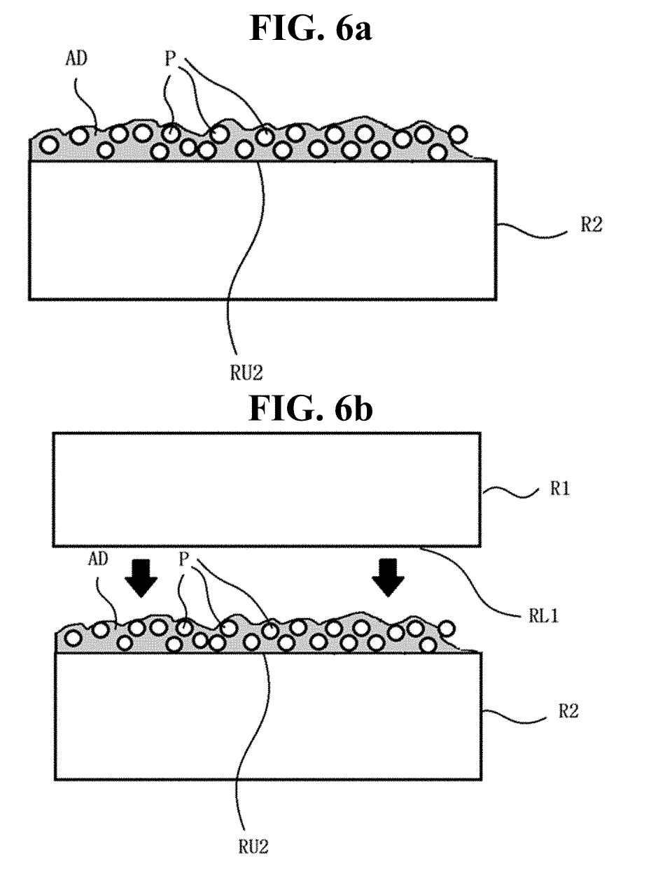

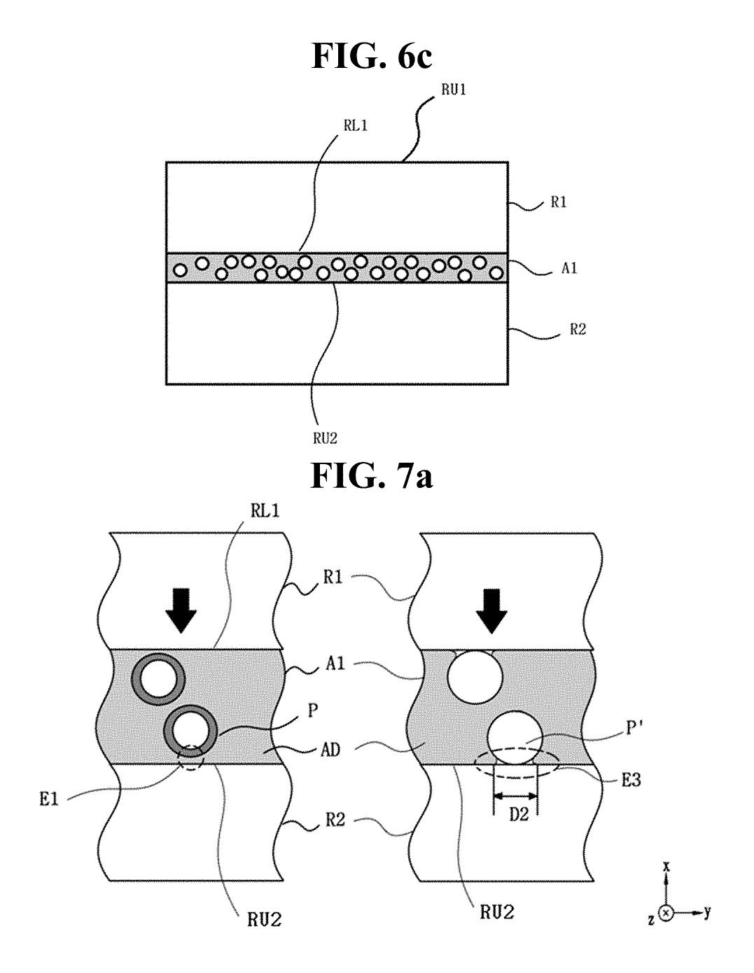

FIGS. 6a to 6c are cross-sectional views showing a method of manufacturing the magnetic sheet 210A shown in FIG. 4a.

Referring to FIG. 6a, first, the adhesive AD in which the magnetic particles P are dispersed may be applied to the second magnetic sheet portion R2.

Thereafter, as shown in FIG. 6b, the first magnetic sheet portion R1 may be stacked on the applied adhesive AD. At this time, the first magnetic sheet portion R1 may be pressurized at predetermined pressure in a direction denoted by an arrow such that the adhesive AD is uniformly and widely formed on the lower surface RL1 of the first magnetic sheet portion R1.

Therefore, as shown in FIG. 6c, the adhesive portion A1 may be formed between the lower surface RL1 of the first magnetic sheet portion R1 and the upper surface RU2 of the second magnetic sheet portion R2 facing the lower surface RL1.

The above process may be repeatedly performed according to the number of magnetic sheet portions. For example, after the process of FIG. 6c, when the adhesive AD in which the magnetic particles P are dispersed is applied to the upper surface RU1 of the first magnetic sheet portion R1 and another magnetic sheet portion, for example, the third magnetic sheet portion R3 is stacked thereon, the magnetic sheet 210B of FIG. 4b may be formed. In this case, the adhesive portion A3 disposed below the second magnetic sheet portion R3 may be disposed after stacking the third magnetic sheet portion R3 or may be disposed before the process shown in FIG. 6a.

Next, the effects obtained by coating the magnetic particle 510 or P with the coating layer 520 will be described with reference to FIGS. 7a and 7b.

FIG. 7a is a cross-sectional view showing the effect of the magnetic particles P coated with a coating layer 520 according to an embodiment along with a comparison example, and FIG. 7b is an enlarged cross-sectional view of a portion “E3”.

In FIG. 7a, the left figure shows the case where the magnetic particles P having the coating layer formed thereon according to the embodiment are dispersed in the adhesive AD and the right figure shows the case where the magnetic particles without the coating layer according to the comparison example are dispersed in the adhesive AD.

Referring to FIG. 7a, since the first magnetic sheet portion R1 is pressurized in a direction denoted by an arrow through the process of applying the adhesive AD shown in FIG. 6a or the process shown in FIG. 6b, the magnetic particles P and P′ may be located at the edge of the adhesive portion A1 adjacent to the magnetic sheet portion R2.

At this time, as shown in the left figure, the magnetic particle P having the coating layer is pushed toward the edge, since both the coating layer 520 and the adhesive AD include organic materials and affinity therebetween is excellent, the adhesive AD may be present in a portion E1 between the upper surface RU2 of the second magnetic sheet portion R2 and the bottom of the magnetic particle P. Accordingly, the magnetic particle P is not directly brought into contact with the upper surface RU2 of the second magnetic sheet portion R2 but the adhesive is brought into contact with the upper surface RU2 of the second magnetic sheet portion R2, thereby securing adhesion area between the adhesive portion A1 and the upper surface RU2 of the second magnetic sheet portion R2.

In contrast, as shown in the right figure, since the magnetic particle P′ does not include the coating layer, the magnetic particle made of an inorganic material having bad affinity is brought into contact with the adhesive AD made of an organic material. Accordingly, the adhesive is relatively easily separated from the magnetic particle and the adhesive AD may not be present between the upper surface RU2 of the second magnetic sheet portion R2 and the bottom of the magnetic particle P′. In some cases, the magnetic particle may be directly brought into contact with the upper surface RU2 of the second magnetic sheet portion R2. Accordingly, since the adhesive AD is not present in a circular planar area corresponding to the diameter D2, loss of the adhesion area corresponding to the area may occur. The portion E3 will be described in greater detail with reference to FIG. 7b. Referring to FIG. 7b, the adhesive AD has bad affinity with the magnetic particle P′ without the coating layer and thus may not completely surround the bottom of the magnetic particle located at the edge thereof. A cavity C in which the adhesive is not filled is formed between the upper surface RL2 of the second magnetic sheet portion R2 and the magnetic particle, thereby losing the adhesion surface corresponding to the plane of the bottom of the cavity C. Accordingly, if the magnetic particle does not include the coating layer, the adhesion state may not be maintained in the stacked structure, thereby reducing adhesive force. This problem may more frequently occur as the content of the magnetic particles in the adhesive portion increases and as the sizes of the magnetic particles are not uniform.

In contrast, the magnetic sheet according to the embodiment may be robust against change in content of the magnetic particles or influence of the sizes of the magnetic particles on adhesive force due to strong affinity between the coating layer 520 and the adhesive AD.

Meanwhile, at least one recess or roughness caused by a plurality of recesses may be formed in surfaces of the magnetic sheet portions R1 and R2 adjacent to the adhesive portion A1 and configuring the magnetic sheets 210A and 210B according to the embodiment. This will be described with reference to FIG. 8.

FIG. 8 is a cross-sectional view illustrating recesses 810 to 840 disposed in magnetic sheet portions R1 and R2 adjacent to an adhesive portion A1 according to an embodiment. More specifically, FIG. 8 shows a cross section of the adhesive portion A1 and one lower surface RL1 of the magnetic sheet portion R1 adjacent thereto in the magnetic sheet according to the embodiment. In FIG. 8, dark portions of the magnetic particles P1 to P4 indicate ferrite particles and bright edge portions indicate the coating layers 520.

Referring to FIG. 8, in a stacking process, a process of disposing the magnetic sheet on a coil (not shown) or a substrate (not shown) or a process of disposing/using a wireless power reception apparatus (not shown), the lower surface RL1 of the magnetic sheet portion R1 may be pressurized and deformed by the plurality of magnetic particles P1 to P4, thereby forming a plurality of recesses 810 to 840.

For example, the recess 810 located on the leftmost side may be pressurized and formed by the magnetic particle P1 located on the leftmost side and the inside of the recess 810 may be filled with the adhesive AD while the magnetic particle P1 is separated from the lower surface RL1 after pressurization.

The second left recess 820 may be pressurized and formed by the second left magnetic particle P2, and the coating layer 520, the magnetic particle P2 and the adhesive AD may be included (that is, received) in the recess 820.

In some cases, the adhesive may not be received in the second right recess 830 formed by the second right magnetic particle P3 or the rightmost recess 840 formed by the rightmost magnetic particle P4. Only at least a portion of the coating layer 520 of the second right magnetic particle P3 may be received in the second right recess 830, and the rightmost magnetic particle P4 including the coating layer 520 and adhesive AD located therebelow may be received in the rightmost recess 840.

Of course, the four recesses 810 to 840 shown in FIG. 8 and the materials received therein are examples and any combination of the adhesive, the coating layer and the magnetic particle (that is, the ferrite particle) or at least some thereof may be received in the recess formed in one surface of the magnetic sheet portion.

Although the lower surface RL1 in which the recess is not formed is shown as flat on the y-axis, the lower surface may be inclined (not shown) by adjacent recesses or may have a protruding (not shown) cross-sectional shape.

In addition, although the cross section of each of the recesses 810 to 840 has a curved shape corresponding to the upper end surface of the magnetic particle forming each recess, the cross section of each recess may have a curvature different from that of the cross section of the magnetic particle or a cross-sectional shape different from that of the magnetic particle.

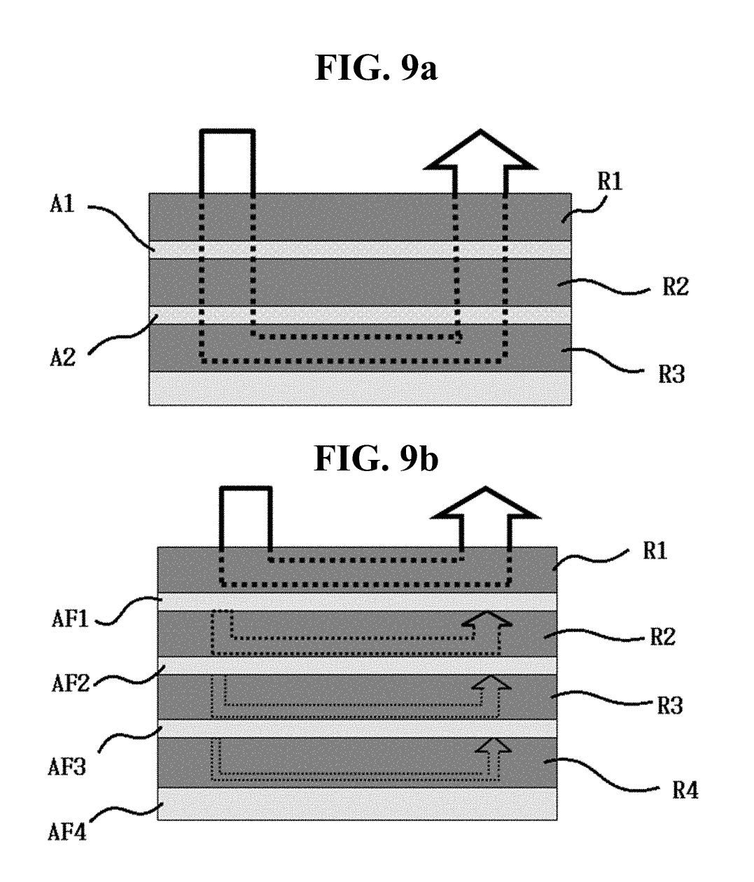

Next, the magnetic properties of the magnetic sheet according to the embodiment and the comparison example will be described with reference to FIGS. 9a and 9b.

FIG. 9a is a cross-sectional view illustrating the magnetic properties of a magnetic sheet according to an embodiment, and FIG. 9b is a cross-sectional view illustrating the magnetic properties of a magnetic sheet according to a comparison example.

Referring to FIG. 9a, since the magnetic particles are included in the adhesive portions A1 and A2 disposed among the magnetic sheet portions R1, R2 and R3, the magnetic sheet according to the embodiment has high effective permeability and thus has low magnetic flux loss.

In contrast, as shown in FIG. 9b, if adhesive films AF1 to AF4 without the magnetic particle are disposed among the magnetic sheet portions R1, R2, R3 and R4, high magnetic flux loss occurs due to the adhesive films made of an insulating material. Therefore, in order to obtain the same effective permeability, more magnetic sheet portions should be stacked as compared to FIG. 9a.

Further, the adhesive film has a structure in which adhesives are disposed above and below a base material (that is, a polymer film). In consideration of this, as the number of stacked magnetic sheet portions increases, the number of adhesive films disposed between the magnetic sheet portions increases. Therefore, the thickness of the magnetic sheet according to the comparison example increases and thinning is difficult.

Meanwhile, according to one embodiment, a metallic ribbon is used as the magnetic sheet portion configuring the magnetic sheet 210 and a crack is formed in the metallic ribbon, thereby reducing eddy current loss.

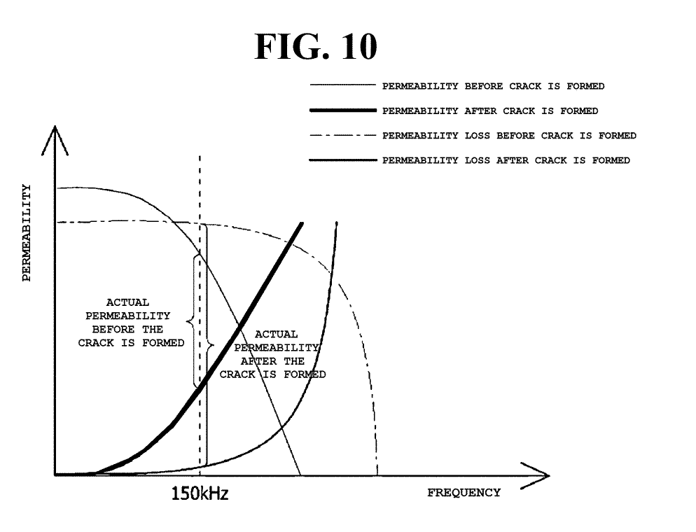

FIG. 10 is a graph showing comparison between actual permeabilities according to each frequency before and after crack is formed in a metallic ribbon.

Referring to FIG. 10, it can be seen that actual permeability after the crack is formed in the metallic ribbon is significantly greater than actual permeability before the crack is formed in the metallic ribbon, in a frequency region used for wireless charging, e.g., about 150 kHz.

If the metallic ribbon is used as the magnetic sheet portion of the magnetic sheet 210, a crack may be formed in the metallic ribbon, thereby reducing eddy current loss and improving transmission efficiency.

Preferably, if a crack having a uniform pattern is formed in the metallic ribbon, it is possible to improve transmission efficiency of the magnetic sheet and to obtain more uniform performance.

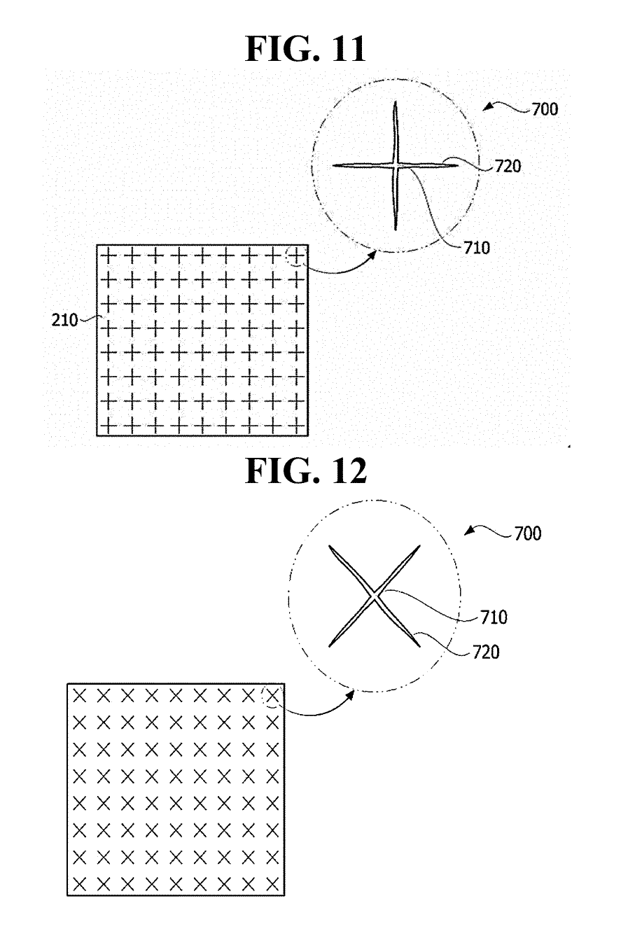

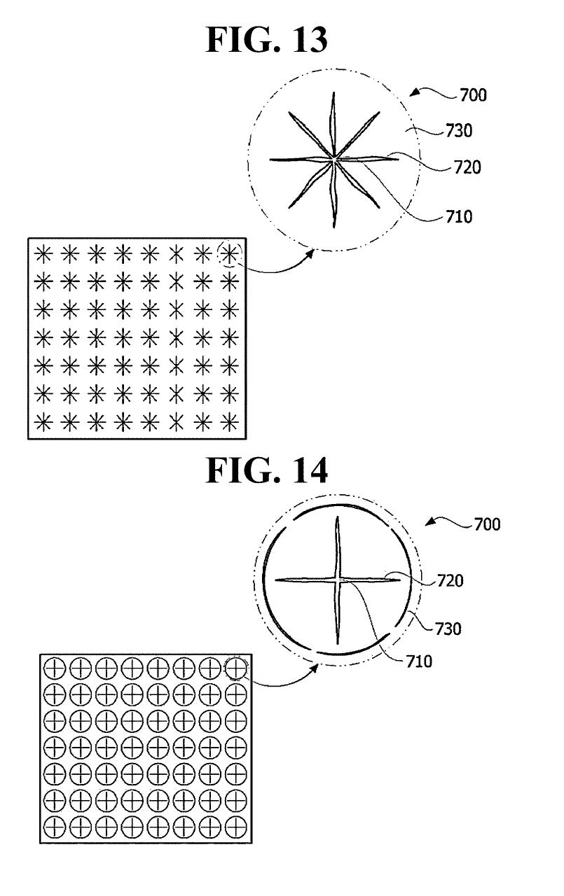

FIGS. 11 to 13 are top views of a magnetic sheet portion according to an embodiment.

Referring to FIGS. 11 to 13, a pattern 700 including three or more lines 720 radiated from a predetermined point 710 is formed in the magnetic sheet portion configuring the magnetic sheet 210. Here, the pattern may be formed as cracks. At this time, a plurality of patterns 700 is repeatedly formed in the magnetic sheet portion and one pattern 700 may be disposed to be surrounded by a plurality of patterns, for example, three to eight patterns 700.

If the repeated pattern is formed in the magnetic sheet portion of the magnetic sheet 210, it is possible to reduce eddy current loss and to obtain uniform expectable transmission efficiency.

At this time, the average diameter of the patterns 700 may be 50 μm to 600 μm. If the diameter of the pattern 700 is less than 50 μm, metallic particles may be excessively present on the surface of the metallic ribbon when the crack is formed. If the metallic particles are present on the surface of the magnetic sheet 210, metallic particles are likely to penetrate into the circuit, thereby causing a short circuit. In contrast, if the diameter of the pattern 700 exceeds 600 μm, a distance between the patterns 700 is large and thus the effect of the crack, that is, actual permeability, may deteriorate.

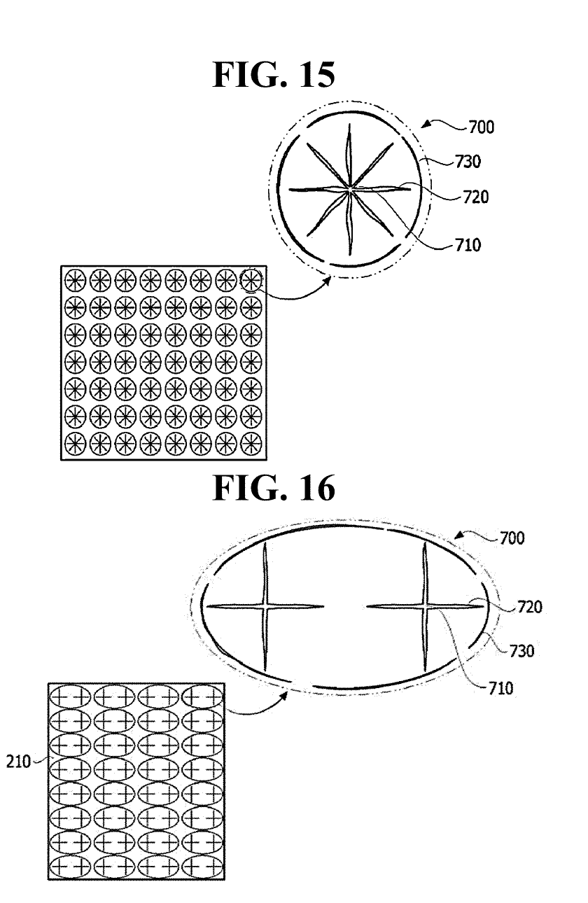

FIGS. 14 to 15 are top views of a magnetic sheet portion according to another embodiment.

Referring to FIGS. 14 to 15, a pattern 700 including three or more lines 720 radiated from a predetermined point 710 and a frame 730 surrounding the same is formed in the magnetic sheet portion of the magnetic sheet 210. Here, the pattern may be formed as cracks. Here, the frame 730 is not a completely cut crack, but is a partially cut crack. At this time, a plurality of patterns 700 is repeatedly formed in the magnetic sheet portion and one pattern 700 may be disposed to be surrounded by a plurality of patterns, for example, three to eight patterns 700.

If the repeated pattern is formed in the magnetic sheet portion, it is possible to reduce eddy current loss and to obtain uniform expectable transmission efficiency.

At this time, the average diameter of the patterns 700 may be 50 μm to 600 μm. Since the characteristics of the range of the diameter are similar to the above description, a repeated description will be omitted.

If the pattern 700 includes the frame 730, the effect of the crack is further increased, the boundary between the patterns 700 is clearly distinguished and a repetitive pattern becomes clear, thereby further increasing uniformity of quality.

In addition, a pattern 700 may include six or more lines 720 radiated from a predetermined point 710 and a frame 730 surrounding the same. If six or more lines 720 radiated in the frame 730 are formed, the effect of the crack may be maximized.

FIG. 16 is a top view of a magnetic sheet portion according to another embodiment.

Referring to FIG. 16, the pattern including three or more lines 720 radiated from the predetermined point 710 and a frame 730 surrounding two or more of the lines is formed in the magnetic sheet portion of the magnetic sheet 210. Here, the pattern may be formed as cracks. At this time, a plurality of patterns 700 is repeatedly formed in the magnetic sheet portion and one pattern 700 may be disposed to be surrounded by a plurality of patterns, for example, three to eight patterns 700.

Meanwhile, a cracking process may include applying pressure to the magnetic sheet portion to perform surface patterning or applying certain cracking force to the surface to crack an internal structure. By including a cracked structure in the surface or the internal structure, it is possible to reduce permeability and to further increase transmission efficiency. For example, pressurization may be performed using a roller made of urethane and having a protruding pattern, in order to form a crack having a uniform pattern in the metallic ribbon. It is possible to uniformly form the crack pattern in the roller made of urethane as compared to a roller made of metal, and to minimize a phenomenon wherein metallic particles remain in the surface of the metallic ribbon. At this time, the pressurization process may be performed at 25 to 200° C. and 10 to 3000 Pa for 10 minutes.

By using the metallic ribbon in which a crack having a repetitive pattern is formed in at least a portion of the magnetic sheet portion configuring the magnetic sheet of the wireless power reception device, it is possible to increase permeability and saturation magnetization and to reduce eddy current loss. In addition, by forming a crack having a uniform pattern in the metallic ribbon, it is possible to increase transmission efficiency and to obtain uniform expectable performance. Of course, in some embodiments, a metallic ribbon in which a crack having a random shape is formed in the magnetic sheet portion may be used.

Meanwhile, according to one embodiment, in the magnetic sheet 210 having a structure in which a plurality of magnetic sheet portions is stacked, some magnetic sheet portions may have a structure which is not subjected to a cracking or breaking process (hereinafter referred to as a non-cracked structure) and the other magnetic sheet portions may have a cracked structure.

For example, magnetic sheet portions having a structure which is not subjected to the cracking or breaking process (hereinafter referred to as non-cracked magnetic sheet portions) may be disposed in one or both of an uppermost magnetic sheet portion and a lowermost magnetic sheet portion.

The structure in which the outermost magnetic sheet portions having the non-cracked structure are stacked can solve a problem that salt water permeates in the subsequent processes due to the cracked structure of the remaining magnetic sheet portions and solve a problem that the cracked structure is exposed to the external surface of the magnetic sheet, damaging a protective film in subsequent processes.

In particular, the magnetic sheet portion having the cracked structure according to the embodiment has relatively lower permeability than the magnetic sheet portion having the non-cracked structure and has relatively higher porosity than the magnetic sheet portion having the non-cracked structure.

Although the adhesive in which the plurality of magnetic particles coated with the organic material are dispersed is focused upon as the adhesive portion in the embodiments, the embodiments are not limited thereto and the adhesive portion may be composed of an adhesive film in which an adhesive, in which magnetic particles are dispersed, is applied to at least one surface thereof.

Although the preferred embodiments of the present disclosure have been disclosed for illustrative purposes, the embodiments are only exemplified, but do not limit the present disclosure. Those skilled in the art will appreciate that various modifications and applications are possible, without departing from the scope and spirit of the disclosure as disclosed in the accompanying claims. For example, in embodiments of the present disclosure, the type of substrate, the depth of trenches, the slope of the sides of trenches, an etching method, etc. can be variously modified and implemented so as to improve the performance of a semiconductor light emitting device, such as luminance. Further, differences related to such modifications and applications should be interpreted as being included in the scope of the present disclosure defined by the accompanying claims.

1. A magnetic sheet comprising:
a first magnetic sheet portion including a first surface;
a second magnetic sheet portion including a second surface facing the first surface; and
an adhesive portion disposed between the first surface and the second surface,
wherein the adhesive portion comprises:
an adhesive including an organic material;
a plurality of magnetic particles; and
a coating layer applied to the plurality of magnetic particles and including an organic material,
wherein at least some of the plurality of magnetic particles are dispersed in the adhesive.

2. The magnetic sheet according to claim 1, wherein a thickness of the coating layer is 10 nm to 100 nm.

3. The magnetic sheet according to claim 1, wherein a weight ratio of the magnetic particles is 50% or less that of the adhesive portion.

4. (canceled)

5. The magnetic sheet according to claim 1, wherein a thickness of the adhesive portion in a direction from the first surface to the second surface is 0.1 μm to 10 μm.

6. The magnetic sheet according to claim 1, wherein a thickness of each of the first and second magnetic sheet portions is 10 μm to 200 μm.

7. The magnetic sheet according to claim 1,
wherein at least one of the first and second surfaces comprises a recess, and
wherein the recess receives at least one of selected from the magnetic particles, the coating layer, and the adhesive.

8. The magnetic sheet according to claim 1, wherein, in at least one of the first and second magnetic sheet portions, a plurality of patterns including three or more lines radiated from a predetermined point is formed.

9. The magnetic sheet according to claim 1, wherein the magnetic particles comprise a ferrite component.

10. A wireless power reception device for receiving power from a wireless power transmission device, the wireless power reception device comprising:
a substrate;
a magnetic sheet disposed on the substrate; and
a coil disposed on the magnetic sheet to receive electromagnetic energy radiated from the wireless power transmission device,
wherein the magnetic sheet comprises:
a first magnetic sheet portion including a first surface;
a second magnetic sheet portion including a second surface facing the first surface; and
an adhesive portion disposed between the first surface and the second surface, and
wherein the adhesive portion comprises:
an adhesive including an organic material;
a plurality of magnetic particles; and
a coating layer applied to the plurality of magnetic particles and including an organic material,
wherein at least some of the plurality of magnetic particles are dispersed in the adhesive.

11. The magnetic sheet according to claim 1, wherein the adhesive comprises at least one of acrylic resin, urethane resin, epoxy resin, silicon resin, phenol resin, amino resin, unsaturated polyester resin, polyurethane resin, urea resin, melamine resin, polymide resin, diallyl phthalate resin, and modified resins thereof.

12. The magnetic sheet according to claim 1, wherein the coating layer comprises at least aminosilane, vinylsilane, epoxysilane, methacrylsilane, alkylsilane, phenylsilane, and chlorosilane as the organic material.

13. The magnetic sheet according to claim 1, wherein a thickness of the adhesive portion in a direction from the first surface to the second surface is uniform.

14. The magnetic sheet according to claim 1, wherein a thickness of the adhesive portion in a direction from the first surface to the second surface is not uniform.

15. The magnetic sheet according to claim 8, wherein the plurality of patterns are formed as cracks.

16. The magnetic sheet according to claim 8, wherein the plurality of patterns further comprises frame surrounding two or more of the three or more lines.

17. The magnetic sheet according to claim 1, wherein at least one of the first magnetic sheet portion and the second magnetic sheet portion includes a metallic ribbon.
